(19) United States
(12) Patent Application Publication
(10) Pub. No.: US 2012/0057615 A1
(43) Pub. Date: Mar. 8, 2012

(54) INFRARED CLINICAL THERMOMETER ABLE TO COMMUNICATE

(76) Inventor: Vincent WENG, Hsinchu City (TW)

(21) Appl. No.: 13/217,761

(22) Filed: Aug. 25, 2011

(30) Foreign Application Priority Data
Sep. 7, 2010 (TW) 099130147

(51) Int. Cl. G01J 5/00

(52) U.S. Cl. 374/128

(57) ABSTRACT

An infrared clinical thermometer able to communicate is disclosed. The infrared clinical thermometer has a control module arranged inside a casing and electrically connected with an infrared body temperature sensation unit, a communication interface, a measurement key, a transmission key, and a power key. When intending to measure body temperature, the user presses the power key to start the infrared clinical thermometer. According to the signal of the measurement key, the control module controls the infrared body temperature sensation unit to detect body temperature. When intending to transmit measurement results, the user links the communication interface to the computer via a detachable communication cable and then presses the transmission key or common key. Then, the control module transmits measurement results to the computer. The infrared clinical thermometer is detachably linked to the computer and thus easy to measure temperature and transmit data.

### BACKGROUND OF THE INVENTION

1. Field of the Invention

The present invention relates to an infrared clinical thermometer, particularly to an infrared clinical thermometer using a detachable communication cable.

2. Description of the Related Art

The conventional ear thermometer is electrically connected with a computer via a cable. The body temperature data is instantly transmitted to the computer via the cable for analysis and storage. The computer and the ear thermometer are placed on a handcart, and the medical staff pushes the handcart to the wards for measuring body temperature. However, the operation is usually constrained by length of the cable. Besides, the cable is likely to tangle and hard to collect.

A wireless technology was developed to solve the abovementioned problems, wherein the computer and the ear thermometer are not connected via a cable but separate to each other, wherein body temperature data is transmitted to the computer for analysis and storage wirelessly. However, such a scheme also has some problems. For example, the wireless transceivers installed in the ear thermometer and the computer for communication increase cost. Further, the transceiver increases power consumption and shorten the running time of batteries. Besides, wireless transmission is likely to interfere with or be interfered with by other apparatuses.

Accordingly, the present invention proposes a new infrared clinical thermometer to overcome the abovementioned problems and provide the medical field for an advantageous option.

### SUMMARY OF THE INVENTION

The primary objective of the present invention is to provide an infrared clinical thermometer able to communicate, which has a socket arranged on a casing, wherein a communication cable having plugs is detachably plugged in the socket to communicate with a computer via USB connectors or RS232 connectors, and wherein the infrared clinical thermometer is connected with the computer only during transmitting body temperature data, whereby the infrared clinical thermometer would not be restricted by a cable like a wireless infrared clinical thermometer when measuring body temperature, wherefore are avoided the drawbacks of the conventional wired and wireless clinical thermometers.

To achieve the abovementioned objective, the present invention proposes an infrared clinical thermometer able to communicate, which comprises a casing, an infrared body temperature sensation unit arranged in the casing and used to measure body temperature, a control module electrically connected with the infrared body temperature sensation unit, and a measurement key arranged on the casing and electrically connected with the control module. When intending to measure body temperature, the user presses the measurement key. Then, the infrared body temperature sensation unit measures the body temperature of a testee, and the control module converts the data of body temperature and other measured data into measurement results and stores them. The present invention further comprises a communication interface including a communication socket arranged on the casing and using a communication cable to selectively connect with one of the computers and transmit measurement results to the computer. The casing further comprises a first press key electrically connected with the control module. When intending to transmit measurement results, the user links the communication interface to the computer and then presses the first press key. Thus, the control module is triggered to transmit signals to the communication interface. Then, the signals are transmitted to the computer via the detachable communication cable.

Below, the embodiments are described in detail in cooperation with the attached drawings to make easily understood the objectives, technical contents, characteristics and accomplishments of the present invention.

### BRIEF DESCRIPTION OF THE DRAWINGS

FIG. 1 is a block diagram of an infrared ear thermometer according to a first embodiment of the present invention;

FIG. 2 is a perspective view schematically showing an infrared ear thermometer according to the first embodiment of the present invention;

FIG. 3 is a perspective view schematically showing the measurement operation of an infrared ear thermometer according to the first embodiment of the present invention;

FIG. 4 is a perspective view schematically showing the transmission operation of an infrared ear thermometer according to the first embodiment of the present invention;

FIG. 5 is a block diagram of an infrared ear thermometer according to a second embodiment of the present invention;

FIG. 6 is a perspective view schematically showing an infrared ear thermometer according to the second embodiment of the present invention; and

FIG. 7 is a perspective view schematically showing an infrared ear thermometer according to the third embodiment of the present invention.

### DETAILED DESCRIPTION OF THE INVENTION

At present, the clinical thermometers used in hospitals normally connect with a computer and transmit body temperature data in a wired or wireless way. However, the conventional communication technologies have many drawbacks. Thus, the present invention proposes an infrared clinical thermometer, which is linked to a computer via a physical cable when transmitting data and exempted from constraint of a cable when measuring body temperature. Therefore, the present invention is free of disadvantages of the conventional technologies but keeps advantages of the conventional technologies.

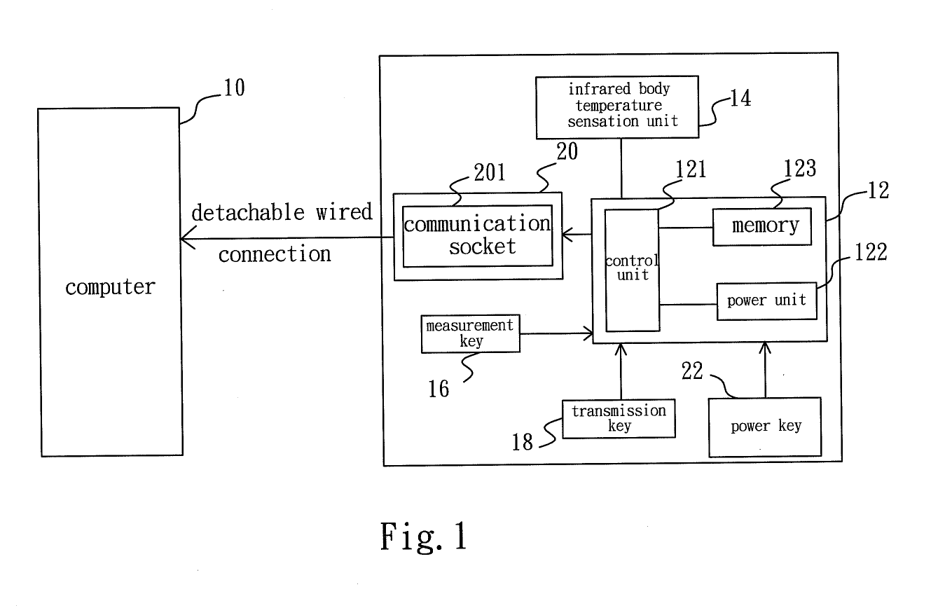

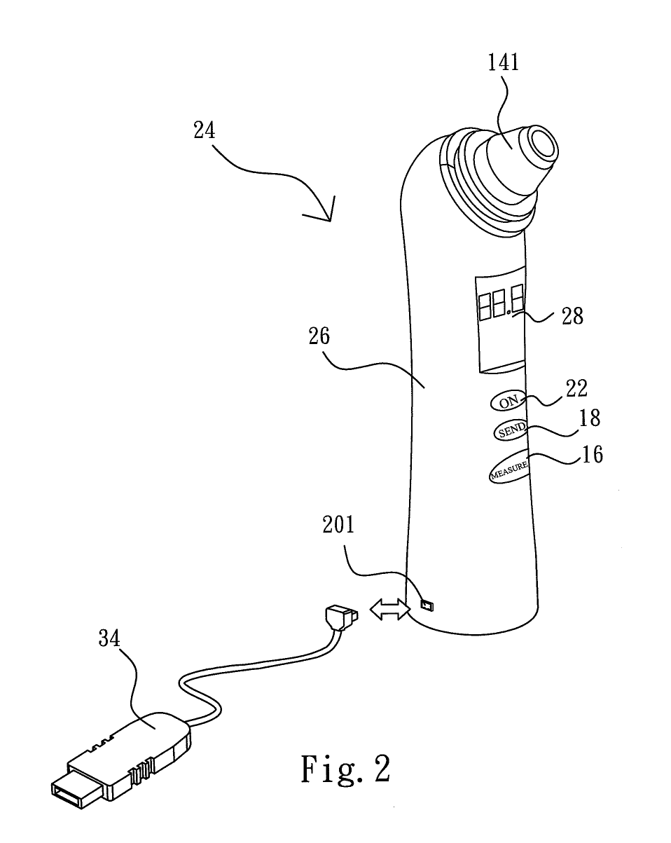

Refer to FIG. 1 and FIG. 2 for an infrared ear thermometer according to a first embodiment of the present invention. The infrared ear thermometer 24 of the present invention comprises a casing 26, a probe 141 arranged on the casing 26, an infrared body temperature sensation unit 14 arranged in the probe 141, a power key 22, a measurement key 16, a transmission key 18, and a screen 28 for showing the status and measurement results of the ear thermometer. The infrared ear thermometer 24 of the present invention comprises a control module 12, which includes a control chip 121, a power unit 122 and a memory 123. The power unit 122 supplies power to the control module 12 executing activities of the infrared clinical thermometer. The memory 123 stores data, such as body temperatures and the measurement time thereof. The control module 12 is electrically connected with the infrared body temperature sensation unit 14 that senses the ear temperature of a testee. The measurement key 16 is electrically connected with the control module 12 to determine whether to detect the body temperature of a testee. When receiving the signal of the measurement key 16, the control chip 121 instructs the infrared body temperature sensation unit 14 to detect the ear temperature of the testee. The infrared body temperature sensation unit 14 transmits the detected temperature signal to the control chip 121, and the control chip 121 converts the detected temperature signal into a measurement result, including a measured temperature value, the measurement time and date thereof. The transmission key 18 is electrically connected with the control module 12. The present invention also comprises a communication interface 20 able to connect with or disconnect from a computer. The communication interface 20 is based on a protocol of a computer bus interface, such as USB, RS232, SPI, UART, or Î2C, etc. In the first embodiment, the communication interface 20 is based on the USB communication protocol. The communication interface 20 includes a communication socket 201 arranged on the casing 26 and plugged in by a USB connection cable 34 for communication with a computer 10. In the first embodiment, communication is realized via a USB connection cable 34. One end of the USB connection cable 34 is inserted into the communication socket 201 and electrically connected with the control module 12 via the communication interface 20. The other end of the USB connection cable 34 is electrically connected with a USB connection port of the computer 10. When intending to transmit measurement results to the computer 10, the nursing staff links the communication interface 20 to the computer 10 and then presses the transmission key 18. Once receiving the signal of the transmission key 18, the control chip 121 sends a transmission signal to the communication interface 20. Once receiving the transmission signal, the communication interface 20 transmits the measurement results to the computer 10. The present invention may further have a power key 22 electrically connected with the control module 12.

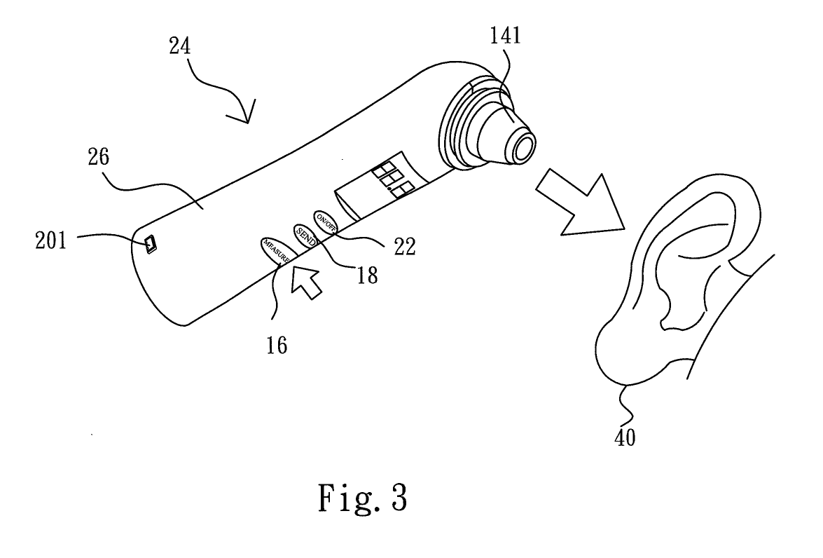

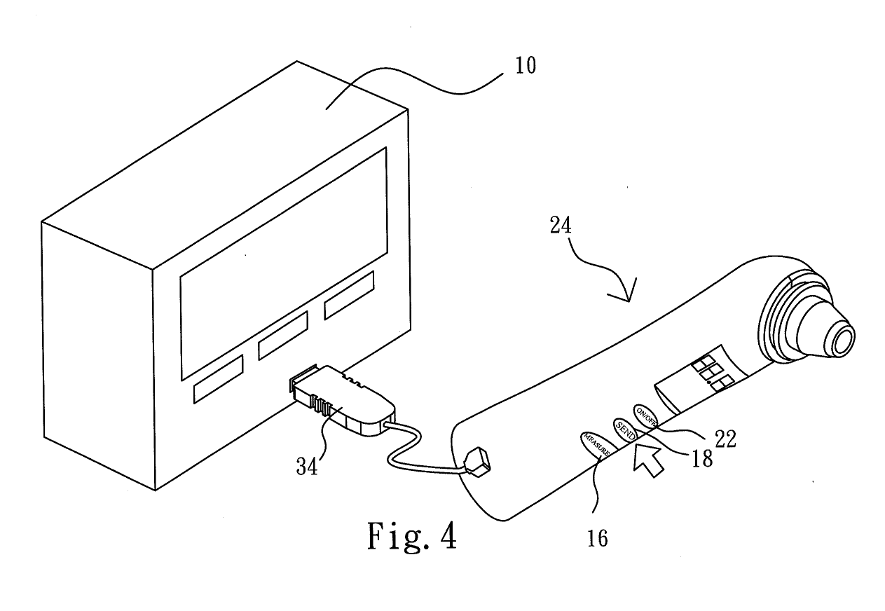

Normally, a ward is equipped with a computer and has several sickbeds respectively accommodating several patients. The computer records the physiological data of the patients. Below is described a typical application of the present invention. The nursing staff uses the ear thermometer to measure the temperature of the ear 40 of Patient A. As shown in FIG. 3, the nursing staff presses the measurement key 30 of the ear thermometer 24 to detect the body temperature of Patient A. In such a case, the ear thermometer 24 does not link to the computer but detects the body temperature of Patient A in a disconnected state. Therefore, the nursing staff can use the ear thermometer 24 to measure the body temperature without being restricted by wiring or length of the cable. The measurement results are temporarily recorded in the memory of the ear thermometer 24. As shown in FIG. 4, the nursing staff uses the USB connection cable 34 to link the ear thermometer 24 to the computer 10 and then presses the transmission key 32, whereby the measurement results stored in the ear thermometer 24 is transmitted to the file of Patient A in the computer 10. In the first embodiment, the internal circuit of the ear thermometer has a communication interface 20 having a communication socket 201 arranged on the casing 26 and electrically connected with the control module 12, as shown in FIG. 1. When intending to measure the body temperature of a testee, the nursing staff needn't couple the USB connection cable 34 plugged in the communication socket 201 to the computer but uses the ear thermometer to measure the body temperature of the testee in a disconnected state. The control chip 121 then converts the body temperature into a measurement result and stores the measurement result in the memory 123. When intending to use the computer 10 to record and analyze the measurement data, the nursing staff links the communication interface 20 to the computer 10 via the USB connection cable 34 and presses the transmission key 18 to transmit the measurement result to the computer 10. Then, the nursing staff disconnects the ear thermometer 24 from the computer 10 and continues to measure the body temperature of other patients.

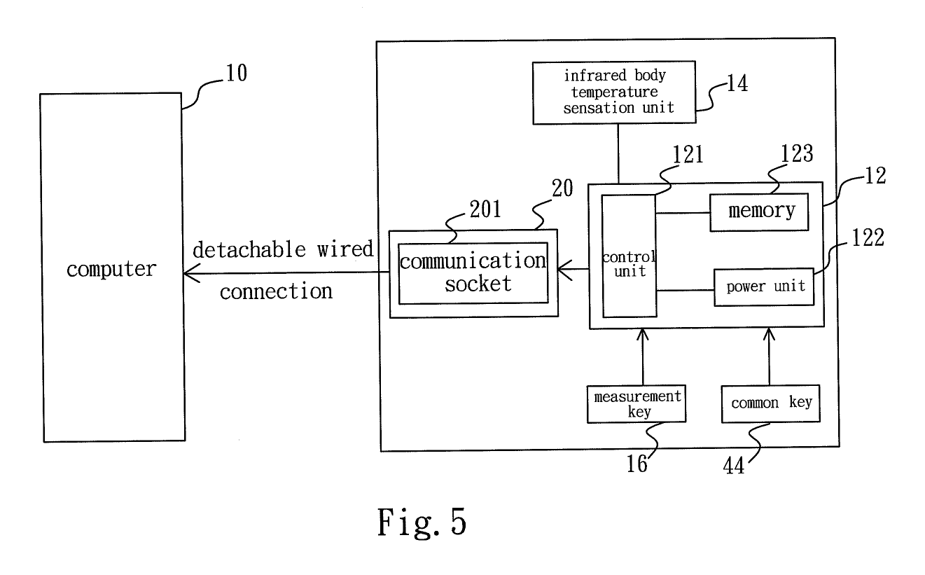

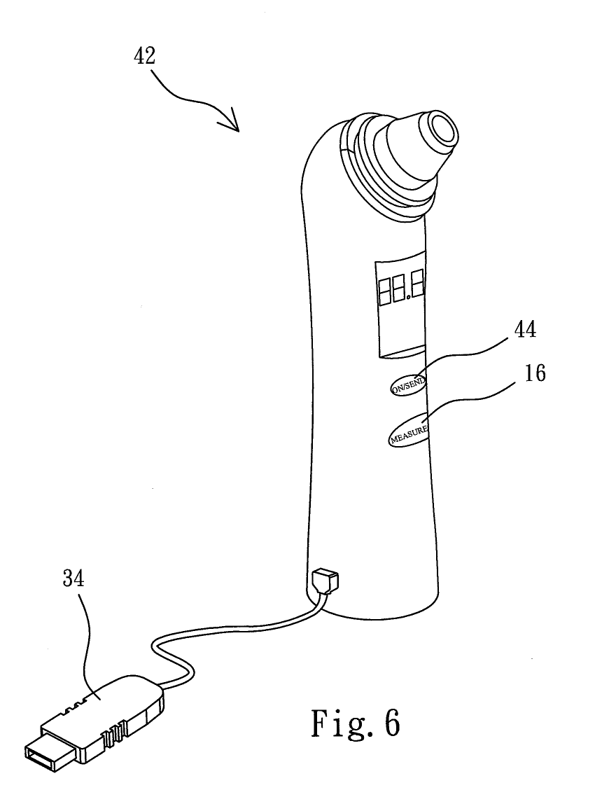

Refer to FIG. 5 and FIG. 6 for a second embodiment of the present invention, wherein the transmission key and the power key are integrated into a common key 44 with the measurement key being preserved. If the power unit 122 is off, pressing the common key 44 turns on the infrared clinical thermometer. If infrared clinical thermometer has been turned on and linked to the computer 10, pressing the common key 44 triggers the control chip 121 to transmit the measurement results to the computer 10.

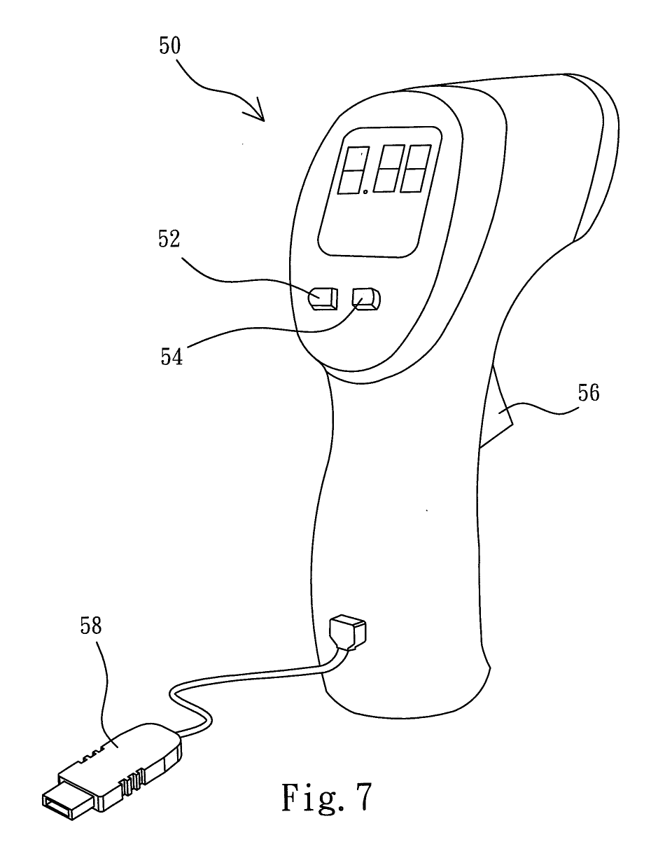

Refer to FIG. 7 for an infrared clinical thermometer according to a third embodiment of the present invention. In the third embodiment, the infrared clinical thermometer is a forehead thermometer 50 having a transmission key 52, a power key 54 and a measurement key 56. The forehead thermometer 50 can be connected with a USB or RS232 connection cable 58 for transmitting data to a computer. As to the circuitry of the forehead thermometer 50, please refer to the first embodiment. The other technical details of the third embodiment are similar to that of the abovementioned embodiments and will not repeat here.

In the abovementioned forehead thermometer, the transmission key and the power key can be realized with a common key. The details thereof are similar to the second embodiment and will not repeat further.

In conclusion, the present invention can solve the problems that the conventional technologies are hard to avoid. In the present invention, the infrared clinical thermometer can be selectively disconnected from the computer, whereby temperature measurement is easy to undertake and exempt from being constrained by cable length. Further, the communication interface of the present invention is small, easy to collect and convenient to use. In transmission of temperature data, the infrared clinical thermometer of the present invention is linked to the computer via a physical cable. Therefore, the problems of wireless transmission would not occur in the present invention.

The embodiments described above are only to exemplify the present invention to enable the persons skilled in the art to understand, make and use the present invention. However, it is not intended to limit the scope of the present invention. Any equivalent modification or variation according to the spirit of the present invention is to be also included within the scope of the present invention.

What is claimed is:

1. An infrared clinical thermometer able to communicate, comprising a casing;
an infrared body temperature sensation unit arranged in said casing;
a control module arranged in said casing and electrically connected with said infrared body temperature sensation unit;
a measurement key arranged on said casing and electrically connected with said control module, wherein said control module controls said infrared body temperature sensation unit to detect a temperature signal of a testee according to a signal of said measurement key, converts said temperature signal into a measurement result, and stores said measurement result;
a communication interface electrically connected with said control module and comprising a communication socket, wherein a detachable communication cable is selectively plugged in said communication socket to form electric connection between said communication interface and a computer; and
a first press key arranged on said casing and electrically connected with said control module, wherein when said measurement result is transmitted to said computer, said control module is electrically connected with said computer via said communication interface, and wherein according to a transmission signal output by said first press key, said control module transmits said measurement result stored thereinside to said communication interface, and then said communication interface transmits said measurement result to said computer.

2. The infrared clinical thermometer able to communicate according to claim 1, wherein said communication interface has a USB, RS232, SPI, UART or I²C communication protocol to implement communication between said communication interface and said computer.

3. The infrared clinical thermometer able to communicate according to claim 1, further comprising a second press key arranged on said casing and electrically connected with said control module, wherein said control module turns on or off said infrared clinical thermometer according to an action of said second press key.

4. The infrared clinical thermometer able to communicate according to claim 1, wherein said control module starts said infrared clinical thermometer according an action of said first press key, and wherein said control module transmits said measurement result according to an action of said first press key.

5. The infrared clinical thermometer able to communicate according to claim 1, wherein said measurement data includes time points and dates of measurement in addition to measured temperature values.

6. The infrared clinical thermometer able to communicate according to claim 1, wherein said temperature signal is obtained via measuring ear temperature or forehead temperature of said testee.
